(19) United States
(12) Patent Application Publication
(10) Pub. No.: US 2019/0378110 A1
(43) Pub. Date: Dec. 12, 2019

(54) SYSTEM AND METHOD FOR PROVIDNG CONSUMER CREDIT

(71) Applicant: Isaac Steinmetz, Lakewood, NJ (US)

(72) Inventor: Isaac Steinmetz, Lower Merion Township, PA (US)

(21) Appl. No.: 16/002,257

(22) Filed: Jun. 7, 2018

(51) Int. Cl. G06Q 20/24; G06Q 40/02; G06Q 20/20

(52) U.S. Cl. CPC G06Q 20/24; G06Q 20/20; G06Q 40/025

(57) ABSTRACT

The present invention provides for customizable credit an installment plan purchases accessible by a consumer at a point-of-transaction.

### INDEX TO RELATED APPLICATIONS

This application is a non-provisional of and claims benefit to U.S. Provisional Patent Application Ser. No. 62/516,982 filed Jun. 8, 2017, the disclosure of which is incorporated herein by reference in its entirety.

### BACKGROUND OF THE INVENTION

The present invention is a system and method to seamlessly and independently allow consumers to create an installment payment plan of their choosing when conducting any network based transaction for purchases and/or services rendered.

Currently there is no available consumer installment payment plans that do not require an initial intensive approval process for either the merchant and/or consumer, by a third party provider (i.e. bank, credit card, credit processor, etc.) for additional access to capital.

All the existing services available for installment payments options, require the consumer or merchant to first obtain a new line of credit/access to capital, and require the preferred installment payment plan be approved by the participating merchant and/or provider.

The market has a complex web of relationships between banking institutions and merchants, that usually leave the consumer paying an exorbitant sum (for example, ˜26% APR) for the ability to conduct a transaction using an installment plan.

This means that merchants must first have the desire, and capability to offer an installment service to the consumer, leaving the consumer at the merchants' will.

The present invention will put the control in the consumer's hand, to create an installment plan of their choosing, at their own discretion, and discreetly without requiring the merchants knowledge or approval.

### SUMMARY OF THE INVENTION

In one embodiment, the present invention is a system for managing and extending consumer credit said system comprising:
a program stored on a host computer operated by credit extending entity, said host computer operatively associated with communications configured for consumer financial transactions; a consumer account stored on said host computer;
at least one verified funding source associated with said consumer account;
a customizable consumer installment plan associated with said consumer account, whereby said installment plan is accessible and actuated by a consumer associated with said consumer account prior and/or during the occurrence of a financial transaction involving sale of goods and/or services in any of phone, online, in store, in person, or combinations thereof;
an automated payment processor operatively associated with said customizable consumer installment plan whereby payments on said consumer installment plan are automatically processed at preselected time intervals to said credit extending entity.

In one embodiment, the present invention is a system for managing and extending consumer credit and to facilitate installment payment plans, said system comprising:
a program stored on a host computer operated by credit extending entity, said host computer operatively associated with communications configured for consumer financial transactions; a consumer account stored on said host computer;
at least one verified funding source associated with said consumer account;
a customizable consumer installment plan associated with said consumer account,
whereby said installment plan is accessible and actuated by a consumer associated with said consumer account at either prior to or during a transaction, optionally, said customizable consumer installment plan including a transaction fee deducted from said consumer account at a time of purchase;
an automated payment processor platform operatively associated with said customizable consumer installment plan whereby payments on said consumer installment plan are automatically processed at preselected time intervals to said credit extending entity.

In one embodiment, the customizable consumer installment plan is accessed prior and/or during the occurrence of a financial transaction involving sale of goods and/or services in any of phone, online, in store, in person, or combinations thereof.

In one embodiment, the customizable consumer installment plan is accessed prior and/or during a consumer transaction.

In one embodiment, the customizable consumer installment plan provides immediate point of transaction payment to a seller or provider of services including, but not limited to, a merchant in an online or phone seller/brick and mortar store/service provider. As used herein, all references to seller or provider include, but are not limited to, merchants.

In one embodiment, the customizable consumer installment plan provides funding for up to 100% of a point of transaction purchase.

In one embodiment, the customizable consumer installment plan provides funding with a preset limit at a point of transaction purchase.

In one embodiment, the customizable consumer installment plan is configured to combine cash, credit card, and installment funds in combination at prior and/or during the occurrence of a financial transaction involving sale of goods and/or services, in any of phone, online, in store, in person, or combinations thereof.

In one embodiment, the present invention is a method of providing funds for a point of transaction purchase, said method comprising the steps of:
providing a system according to the present invention;
enrolling a consumer in said system;
configuring said system to provide a payment plan for said consumer at a point of transaction purchase;
providing processing of a points of transaction purchase;
tendering funds to a merchant in said point of transaction purchase;
initiating a consumer installment plan for transaction purchase.

In one embodiment, the customer will have the initial payment on the preferred installment payment plan chosen, plus any transaction fees assessed for said transactions, (including foreign transaction fee, returning customer transaction fee, or any other fees) deducted from their funding account. This fee would be in lieu of charging an interest rate; or in place of a percentage being charged on the principle (at the time of repayment).

In one embodiment, the present invention is a system for managing and extending consumer credit and to facilitate installment payment plans, said system consisting of:
a program stored on a host computer operated by credit extending entity, said host computer operatively associated with communications configured for consumer financial transactions;
a consumer account stored on said host computer;
at least one verified funding source associated with said consumer account;
a customizable consumer installment plan associated with said consumer account, whereby said installment plan is accessible and actuated by a consumer associated with said consumer account at either prior to or during a transaction, said customizable consumer installment plan including a transaction fee deducted from said consumer account at a time of purchase;
an automated payment processor platform operatively associated with said customizable consumer installment plan whereby payments on said consumer installment plan are automatically processed at preselected time intervals to said credit extending entity.

### BRIEF DESCRIPTION OF THE SEVERAL VIEWS OF THE DRAWINGS

FIG. 1 is a flow chart of one embodiment of the present invention.

### DETAILED DESCRIPTION OF THE PREFERRED EMBODIMENT

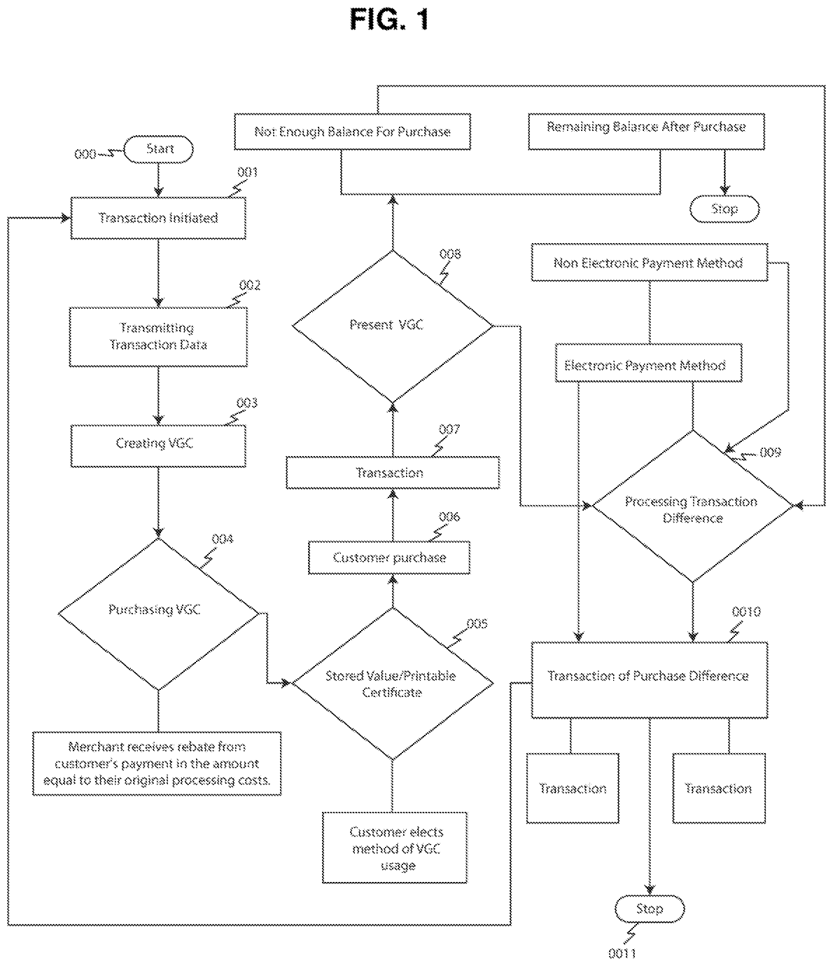

In one embodiment, as detailed in the steps of the system and method of the present invention as demonstrated in FIG. 1, A consumer will initiate a transaction 001, transaction data is transmitted 002, and a virtual card is created 003. Although the specific embodiment provides for issuance of a virtual card, the present invention contemplates and includes embodiments having physical cards, and embodiments with both a physical and virtual card. The virtual card is issued after creation and a particular monetary value can be stored on the computer system maintaining records relating to virtual cards. After purchase of the card 004, stored value 005 is operatively associated with created card 003. The consumer will then make a purchase 006, transaction will be processed 007 by presenting the card 008, and the determination relating to available balance will be processed by the system of the present invention.

In one embodiment, the transaction is evaluated and completed based on processing the transaction difference 009 concluding in the actual transaction of purchase difference 010.

In one embodiment, the invention includes the issuance of an actual (e.g. physical) card. In an embodiment utilizing a physical card, a physical card is created at inception or anytime after inception of relationship, the physical card is then designated to correspond to a funding source such as a bank, one or more bank accounts, credit card, debit credit, or line of credit, that has already been entered into the system of the present invention or that can be entered and linked to the card at a later date.

When a consumer selects an installment plan, the system will initiate a transaction amount, process the transaction and relay payment information to a merchant. In one embodiment, if the system determines there are no funds available for an installment plan, the transaction will be processed through the consumers existing funding account/s

With the present invention, consumers will use their existing access to capital and credit to schedule the installment payment plan of their choosing.

The present invention also contemplates using the existing credit cards/line of credit available to consumers, to create a uniquely suited installment plan to be used for any consumer related product or service purchase/payment.

The present invention is configured to create a consumer installment payment option (technology) for transactions, either via a simple user friendly mobile application interface to be used at POS, or for online, phone purchases/transactions, and for all other purchases or services related transactions, via a an actual and/or virtual private label credit/debit/prepaid card.

The present invention will enable consumers to link their existing funding accounts/lines of credit to a unique account and co-branded card to allow for a uniquely designed, efficient, and affordable installment payment plan.

In certain embodiments, the present invention is configured as follows:
Utilizing existing consumer credit/debit cards, and/or lines of credit, bank accounts, or any existing access to capital and credit to fund the transaction.
To facilitate an installment payment plan option for all consumer transactions via a payment system.
No credit inquiries or approvals needed for consumers.
No signups or approvals required by merchants.

Account signup and transaction flow will include the following:
The account will be associated with a virtual and/or physical card issued to the customer which will either be 1) an open-loop actual Visa/MC (or any and all card-network issued cards), white label/co-branded card via a potential partnership with a sponsoring bank, and/or 2) a closed-loop branded card; (to include any and all card network issued cards)

### Open-Loop Card

An open-loop credit card and banking information will be stored by the host credit extending entity.
In one embodiment, unique transaction codes/tokens will be generated by the acquiring/issuing bank, and/or credit extending entity for each customer purchase.
To conduct a transaction, a customer will select via the mobile application, including, but not limited to, via the internet and online login to their accounts, and/or via API with the online checkout providers, the preferred payment method/funding account (i.e.: specific credit card, bank account, etc.) and preferred installment package.
Open-loop card provider/issuer/processor, and/or credit extending entity instantaneously confirms the funds are available for the preferred customer funding option.
If confirmed, customer can now conduct any transaction at any POS, internet transaction, or over the phone, either utilizing the open-loop branded card, via a virtual card, or through an NFC transaction utilizing the mobile application from their smartphone.
In one embodiment, the open-loop branded card provider/processor/credit extending entity will authorize a hold on the customer's available funds or lines of credit.
The funds can potentially actually sit on the open-loop branded card, and/or the funds can be passed through the open-loop branded card. The open-loop branded card can store the value of funds to be used for the purchase transaction, and/or the open-loop card can act as proxy pass-through card where no value of funds is actually stored on the card.
Payment in full for the product purchased by the customer will be sent immediately by the credit extending entity/processor/issuer to the merchant party receiving payments for product/services rendered.
Customer will have the initial payment on the preferred installment payment plan chosen, plus any transaction fees assessed for said transaction, (including foreign transaction fee, returning customer transaction fee, or any other fees) deducted from their funding account at the time of purchase.
Open-loop branded card provider/issuer/processor/credit extending entity will re-issue the authorization hold on the customer's credit card periodically and after payments are made under the installment plan, to ensure the funds for the remaining balance on the installment plan are available, minus the payments already cleared and processed under the installment plan.

As generally understood and practiced, extensions of credit typically include payments with interest and sometimes interest paired with an initial origination or transaction fee. The present invention provides a set transaction fee, for example 5% of the loan amount regardless of the term length. This provides a system having only a service fee and not an interest rate.

That is to say, the user/consumer is paying for the service as opposed to paying for the money.

Thus, in one embodiment, the invention includes the customizable consumer installment plan having a transaction fee deducted from the consumer account at a time of purchase, and the transaction fee being for said transaction and in lieu of fees based on any interest rats:

### Closed-Loop Branded Card

Customer credit card and banking info will be tokenized and stored by the closed-loop branded card provider.
In one embodiment, a unique transaction code/token will be generated by the acquiring/issuing bank for each customer purchase.
To conduct a transaction, customer will select via the mobile application, including, but not limited to, via the internet and online login to their accounts, and/or via API with online checkout providers, the preferred payment method/funding account (i.e.: specific credit card, bank account, etc.) and preferred installment package.
Closed-loop branded card provider instantaneously confirms the funds are available for the preferred customer funding option.
If confirmed, customer can now conduct any transaction at any POS, internet transaction, or over the phone, either utilizing the closed-loop branded card provider, via a virtual card, or through a NFC transaction utilizing the mobile application from their smartphone.
In one embodiment, a closed-loop branded card provider will authorize a hold on the customer's available funds or lines of credit or funds may be transferred from a bank account and become associated with the closed-loop branded card.
Payment in full for the product purchased by the customer will be sent immediately to the merchant party receiving payments for product/services rendered.
Customer will have the initial payment on the preferred installment payment plan chosen, and any transaction fees assessed for said transaction, including foreign transaction fees, returning customer transaction fees, or any other fees, deducted from their funding account at the time of purchase.
The closed-loop branded card provider will re-issue the authorization hold on the customer's credit card periodically and after payments are made under the installment plan, to ensure the funds for the remaining balance on the installment plan are available, minus the payments already cleared and processed under the installment plan.

### Merchant Perspective

The transaction will be viewed by the merchant exactly the same as any and all electronic payment system, virtual card based, and/or mobile wallet based purchases/transactions. Merchants will have no knowledge that the consumer is using an installment plan to purchase the product/service.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for managing and extending consumer credit and to facilitate installment payment plans, said system comprising:
a program stored on a host computer operated by credit extending entity, said host computer operatively associated with communications configured for consumer financial transactions;
a consumer account stored on said host computer;
at least one verified funding source associated with said consumer account;
a customizable consumer installment plan associated with said consumer account, whereby said installment plan is accessible and actuated by a consumer associated with said consumer account at either prior to or during a transaction;
an automated payment processor platform operatively associated with said customizable consumer installment plan whereby payments on said consumer installment plan are automatically processed at preselected time intervals to said credit extending entity.

2. The system of claim 1, wherein said customizable consumer installment plan is accessed prior to a transaction.

3. The system of claim 1 wherein customizable consumer installment plan provides immediate point of transaction payment to a merchant.

4. The system of claim 1 wherein customizable consumer installment plan provides funding for up to 100% of a point of transaction purchase.

5. The system of claim 1 wherein customizable consumer installment plan provides funding with a preset limit at either prior or during the occurrence of a transaction.

6. The system of claim 1 wherein customizable consumer installment plan is configured to combine cash, credit card, and installment funds in combination at either prior or during the occurrence of a transaction.

7. The system of claim 1, wherein said customizable consumer installment plan is accessed during a transaction.

8. The system of claim 1, wherein said customizable consumer installment plan is accessed after a transaction up to thirty days.

9. The system of claim 1, wherein said customizable consumer installment plan is accessed during a transaction and includes user selected installment terms.

10. The system of claim 1 wherein said customizable consumer installment plan provides funding for up to 100% of a transaction.

11. The system of claim 1, wherein said customizable consumer installment plan includes providing two or more installment plan terms to a consumer for selection.

12. The system of claim 1, wherein said customizable consumer installment plan including a transaction fee deducted from said consumer account at a time of purchase, said transaction fee being for said transaction and in lieu of fees based on any interest rate.

13. A method of providing funds managing and extending consumer credit and to facilitate installment payment plans, said method comprising the steps of:
providing a system according to claim 1;
enrolling a consumer in said system;
configuring said system to provide a payment plan for said consumer at a point of transaction purchase;
providing processing of the transaction;
tendering funds to a merchant in said point of transaction purchase;
initiating a consumer installment plan for said purchase.
